(19) United States
(12) Patent Application Publication
(10) Pub. No.: US 2015/0158726 A1
(43) Pub. Date: Jun. 11, 2015

(54) Process for Producing Hydrogen with Various Levels of Purity by H2 PSA

(71) Applicant: L'Air Liquide Societe Anonyme Pour l'Etude et l'Exploitation des Procedes Georges Claude, Paris (FR)

(72) Inventors: Francois Fuentes, Le Vesinet (FR); Guillaume Rodrigues, Montigny-Le-Bretonneux (FR)

(21) Appl. No.: 14/404,987

(22) PCT Filed: May 23, 2013
(86) PCT No.: PCT/FR2013/051120

§ 371 Date: Dec. 2, 2014

(30) Foreign Application Priority Data
Jun. 4, 2012 (FR) 1255147

(51) Int. Cl. C01B 3/56; B01D 53/047

(52) U.S. Cl. CPC C01B 3/56; B01D 53/047; C01B 2203/0465; C01B 2203/042; C01B 2203/0425; B01D 2259/4006; B01D 2256/16

(57) ABSTRACT

A process for producing hydrogen from a gas mixture comprising hydrogen (H₂), and at least one impurity to be eliminated using an H₂ PSA unit comprising N adsorbers subjected to a pressure cycle of duration T with N>1, comprising the following successive steps:
a) said gas mixture is introduced into said unit,
b) at least a first hydrogen-enriched stream having a mean impurity content Y_{pd} is extracted,
c) at least a second hydrogen-enriched stream having a mean impurity content Yₕₚ is extracted,
d) at least a third hydrogen-enriched stream having a mean impurity content Y_{pd}′ is extracted,
with Y_{pd}>3Yₕₚ and Y_{pd}′>3Yₕₚ.

### CROSS REFERENCE TO RELATED APPLICATIONS

This application is a §371 of International PCT Application PCT/FR2013/051120, filed May 23, 2013, which claims the benefit of FR 1255147, filed Jun. 4, 2012, both of which are herein incorporated by reference in their entireties.

### TECHNICAL FIELD OF THE INVENTION

The present invention relates to a process for producing hydrogen having various levels of purity.

### BACKGROUND

An increasingly large number of processes henceforth require gases having controlled purity, especially having very high purity (from 99% to 99.9999 mol %). Pollution by certain impurities in the production of these gases may lead to consequences such as accelerated aging of components of the consuming unit. Mention will be made, for example, as consuming unit, of the fuel cell, the sensitivity of the membranes of which requires hydrogen of very high purity with respect to certain impurities. Mention will be made, by way of example, of carbon dioxide, the required specification of which is of the order of 0.1 ppm.

Most of the hydrogen is provided from steam reforming of hydrocarbons, more particularly of methane (SMR). The reformed gas is generally sent to a shift reactor (water-gas shift reactor) in order to produce more hydrogen. The water-gas shift reaction is a reaction between carbon monoxide and water in order to form carbon dioxide and hydrogen.

In general, the gas produced has the following characteristics:
pressure of 15 to 40 bar abs,
temperature close to ambient temperature (after cooling),
composition as molar percentages H₂: between 60% and 80%; CO₂: between 15% and 25%; CO: between 0.5% and 5%; CH₄: between 3% and 7%; N₂: between 0 and 6%, saturated with water,
flow rate: a few thousands to a few hundreds of thousands of Nm³/h.

This syngas is sent most of the time to an adsorption purification unit referred to as a PSA (Pressure Swing Adsorption) unit.

Most PSA units have a control that makes it possible to maintain the purity of the product at the required specification, typically 10 ppm CO on average over a cycle.

When it is desired to increase the purity of the PSA, two main solutions may be considered, the first being a suitable adjustment of the PSA, the second being the addition of a supplementary purification system. Among these additional systems, mention may especially be made of cryogenic traps and TSA (temperature swing adsorption) purification units that are relatively expensive in terms of investment and lead to additional operating costs. The adjustment of the parameters of the PSA that make it possible to comply with a very restrictive specification in terms of purity will make it necessary to reduce the H₂ yield of the unit, which is equivalent to increasing the amount of hydrogen lost by the system and to an increase in the amount of hydrocarbons consumed in order to retain a fixed flow rate of H₂ produced. This solution therefore has additional operating costs, and means that the whole of the H₂ production leaving the PSA will be produced with a reduced yield, including when only one fraction of the production requires a higher purity.

PSA units are used to purify a gas stream or separate it into its constituents. They generally comprise several adsorbers filled with adsorbent materials that are selective with respect to at least one of the constituents of the feed stream. These adsorbers follow a pressure swing cycle comprising a succession of phases which define steps of adsorption at the high pressure of the cycle, of depressurization, of extraction of the most adsorbed components and of repressurization. Generally, the arrangement of the cycle is such that the production is supplied continuously without therefore having the need to provide a storage capacity.

Most PSA units have a control that makes it possible to maintain the purity of the product at the required specification.

This could be, for example, the adaptation of the cycle time. PSA units that treat H₂/CO syngases (H₂ PSA) operate at a given feed gas flow rate, the feedstock coming for example from a natural gas steam reforming unit, by partial oxidation, by gasification of coal or residues, or by mixed processes. A shortening of the cycle time makes it possible to obtain a purer hydrogen fraction, at the expense however of the extraction yield (that is to say the amount of hydrogen actually produced).

Conventionally, during a PSA cycle having at least 4 cylinders, the adsorbers are subjected at least to the following steps:
an adsorption phase at the high pressure of the cycle with gradual increase in the saturation level of the adsorber;
a first depressurization phase without evacuation of the adsorbed gas (only “non-adsorbed” gas present in the dead volumes of the adsorber leaves the adsorber—co-current step);
a second depressurization phase in order to reach the low pressure of the cycle with discharging/desorption of certain adsorbed gases, when the adsorber is at the saturation limit (counter-current step);
an isobaric phase at the low pressure of the cycle referred to as “elution” that is used to continue the discharging (or desorption) of the adsorbed gases. The desorption gas is generally gas resulting from a depressurization step or product gas;
a repressurization phase from the low pressure of the cycle to the high pressure of the cycle with the gas from one of the cylinders under depressurization up to a pressure referred to as equalization pressure;
a repressurization phase from the equalization pressure to the high pressure of the cycle with a gas that may be product gas or feed gas.

In the general case of PSAs, it is customary for the content of impurities to vary during the production phase. In the case where the product gas consists of the least adsorbable compounds, for example in the case of an H₂ PSA, the content Yi of a given impurity i decreases very rapidly at the start of the production step and goes back up more slowly toward the end of the same step.

A typical example of these variations is given in FIG. 1. The high content of impurities at the start of the phase time is explained by the fact that the adsorber in question has just been re-pressurized by means of gas from an adsorber at the end of the production step: the gas produced in the very first instants therefore has the composition of the gas produced at the end of the step (mirror effect).

In other units where the repressurization is carried out differently, in particular in the case of final repressurization by the feed gas, impurity peaks will only be able to be observed at the end of the production step: the adsorbent material becoming saturated in impurities, the latter begin to leave with the production (breakthrough).

### SUMMARY OF THE INVENTION

The process according to the invention makes it possible to produce a gas mixture containing hydrogen having at least 2 different impurity levels.

Starting from here, one problem that is faced is to provide an improved process for producing hydrogen that enables the provision of hydrogen at various purity levels without reduction of the yield.

One solution of the present invention is a process for producing hydrogen from a gas mixture comprising hydrogen (H₂), and at least one impurity to be eliminated using an H₂ PSA unit comprising N adsorbers subjected to a pressure cycle of duration T with N>1, comprising the following successive steps:

a) said gas mixture is introduced into said unit,

b) at least a first hydrogen-enriched stream having a mean impurity content Y_{pd} is extracted,

c) at least a second hydrogen-enriched stream having a mean impurity content Yₕₚ is extracted,

d) at least a third hydrogen-enriched stream having a mean impurity content Y_{pd}′ is extracted,

with Y_{pd}>3Yₕₚ and Y_{pd}′>3Yₕₚ.

Preferably, Y_{pd} will be between 3Yₕₚ and 100 Yₕₚ.

Preferably, the gas mixture is a natural gas steam reforming gas, resulting from a partial oxidation, coal gasification or shift process.

Several configurations may be envisaged in order to obtain streams having different purity levels.

Firstly, the cycles where the production step corresponds to a single phase time, and the cycles involving a large number of cylinders (typically 8 to 12) where there are several adsorbers simultaneously in the production step, and where this production step may spread over several phase times (generally from 2 to 3 phase times), will be distinguished.

Over the cycles where a single adsorber is in the production phase at a time, it will be a question of sequencing this step corresponding to a single phase time:
via the addition of one or two valves to the H₂ production line (FIG. 3—withdrawal of a fraction of the total H₂ flow), the PSA will then alternately produce gas having different purity levels, or
via the addition of a single valve at the outlet of one (or more) adsorber(s) of the PSA (FIG. 4: withdrawal over the adsorber 1), which will make it possible to extract a more limited flow of high-purity gas, and will lead to a reduced fractionation of the production of standard-purity gas.

In this case, the process according to the invention may have one or more of the following characteristics:
the pressure cycle comprises a production phase; at each instant t of the pressure cycle, a single adsorber is in the production phase; the H₂ PSA unit is characterized by a phase time t_{φ}=T/N; and step c) is carried out over a duration d₁ such that 0.05 t_{φ}<d₁<0.5 t_{φ};
step b) is carried out over a duration d₀ such that 0<d₀<0.4 t_{φ},
step d) is carried out over a duration d₂ such that 0.3 t_{φ}<d₂<0.95 t_{φ};
the N adsorbers are connected to one and the same hydrogen production line and steps b), c) and d) are carried out by means of one or two valves located on this hydrogen production line;
steps b), c) and d) are carried out by means of N valves located at the outlet of the N adsorbers.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 provides a graphical representation of the impurity content vs time for the prior art.

FIG. 2 provides a graphical representation of the impurity content vs time for an embodiment of the present invention.

FIG. 3 provides an embodiment of the present invention.

FIG. 4 provides an embodiment of the present invention.

### DETAILED DESCRIPTION

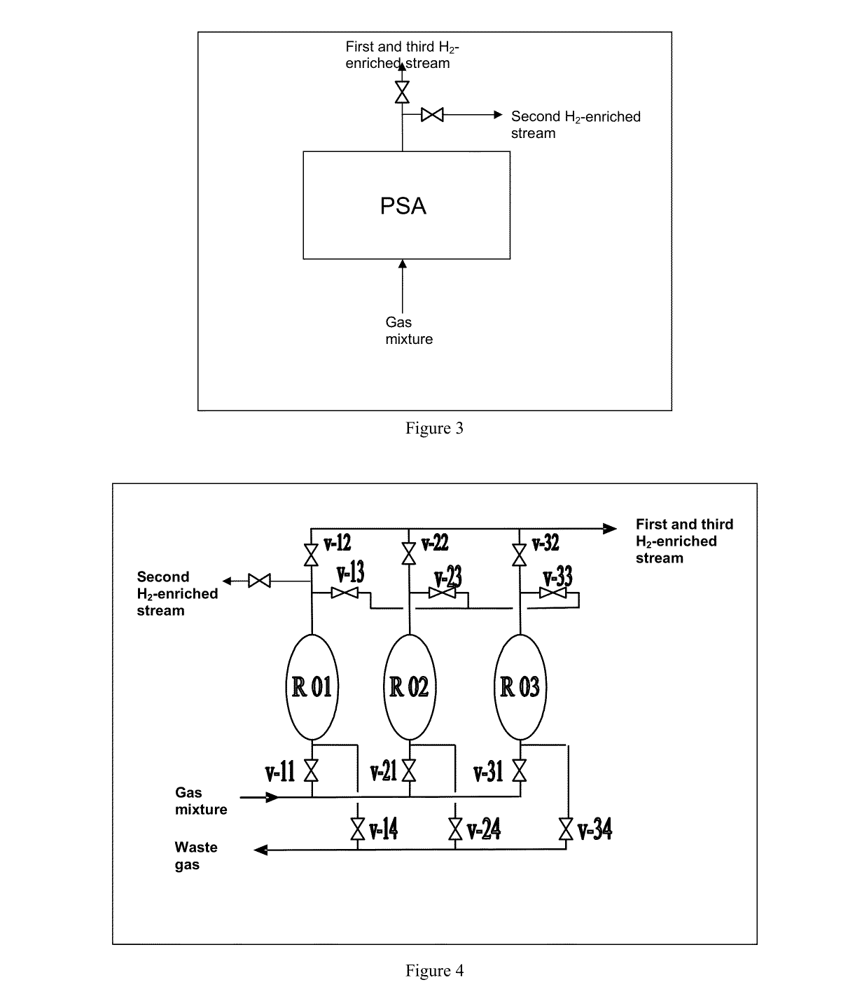

Over the cycles where several adsorbers are simultaneously in production, one of the phase times of the production step could be sequenced (as above) or else the “high-purity” gas, that is to say the second stream, could be withdrawn over a complete phase time. Specifically, for a cycle comprising 3 adsorbers in production, the second production phase time could for example be chosen for withdrawing the higher purity gas. This multi-purity PSA will be obtained:
via the addition of one or two valves to the H₂ production line (FIG. 3—withdrawal of a fraction of the total H₂ flow), the PSA will then alternately produce gas having different purity levels, or
via the addition of a single valve at the outlet of one (or more) adsorber(s) of the PSA (FIG. 4: withdrawal over the adsorber 1), which will make it possible to extract a more limited flow of high-purity gas, and above all to preserve a continuous (but variable) flow of gas at at least one of the purity levels.

In the latter case, the process according to the invention may have one or more of the following characteristics:
the pressure cycle comprises a production phase; several adsorbers are simultaneously in the production phase during the cycle; the H₂ PSA unit is characterized by a phase time t_{φ}=T/N and by a production time tₚ that is a multiple of the phase time; and step c) is carried out over a duration d₁ such that 0.05 tₚ<d₁<0.5 tₚ;
step b) is carried out over a duration d₀ such that 0<d₀<0.4 tₚ;
step d) is carried out over a duration d₂ such that 0.3 tₚ<d₂<0.95 tₚ;
steps b), c) and d) are carried out by means of one to N valves located at the outlet of one to N adsorbers.
the N adsorbers follow the pressure cycle in phase;
the N adsorbers follow the pressure cycle with a phase shift.

Let us take the example of an H₂ PSA where the production time corresponds to a single phase time, designed for a mean impurity content of 10 ppm, and adjusted so that its actual operation is at 2 ppm on average since a specification over the maximum instantaneous content of the PSA is required by the downstream process (at the expense of a loss of yield with respect to a PSA actually operating at 10 ppm on average).

If a maximum (therefore instantaneous) purity of 0.1 ppm at the outlet is necessary over the entire production or more likely a fraction thereof, it will then be necessary to greatly (and therefore unacceptably) degrade the yield in order to achieve a mean content at the outlet of the PSA of less than 50 ppb. All of the hydrogen produced by the PSA will then have such a purity, even if only a fraction of the production requires it.

However, going back to the existence of systematic peaks at the end and/or at the start of the production phase, this implies that between these peaks the impurity content at the outlet of the PSA is lower, or even much lower than the mean content at the outlet. Consequently, by alternately selecting the gas during the peaks and between the peaks, it is then possible to generate two hydrogen streams at very different purity levels, and it is on this principle that the invention presented here is based.

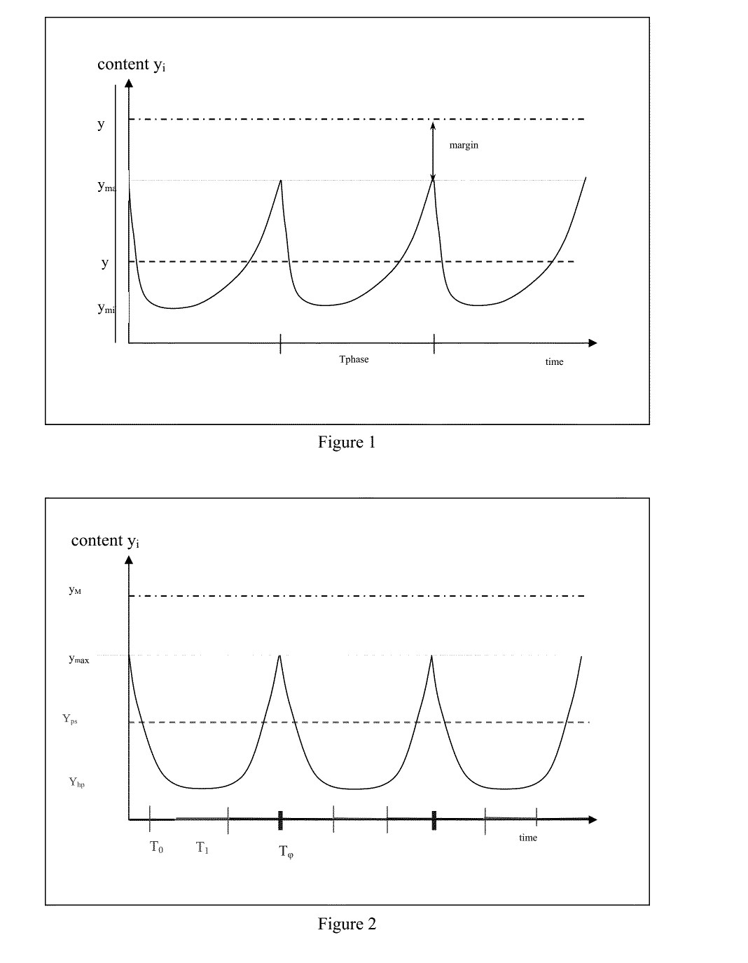

The invention is described in greater detail with the aid of FIG. 2. It will be assumed, in order to simplify the example, that the impurity profile at the outlet of the cylinder during the production step is symmetrical, that is to say that the profile for decrease of the impurity content at the start of the production phase is the mirror of the profile for increase of impurity at the end of the production step. In FIG. 2, the following are noted: t0: the start of the withdrawal of the “high-purity” gas, t1: the end of the withdrawal of the “high-purity” gas and tφ: the phase time of the PSA.

With such a profile, 3 sequences will then be defined on each cylinder in production:

[0-t₀] production of the first stream enriched in hydrogen gas. The mean impurity content during this sequence, Y_{pd}, will be noted.

[t₀-t₁] production of the second hydrogen-enriched stream. The mean impurity content during this sequence, Yₕₚ, will be noted.

[t₁-t_{φ}] production of the third hydrogen-enriched stream. The mean impurity content during this sequence, Y_{pd}, will be noted.

The standard mean purity obtained over a complete phase time (corresponding to the 2 ppm mentioned above), Yₚₛ, will also be noted.

Hence, the expression “high-purity gas” is understood to mean a hydrogen-enriched stream having an impurity content Yₕₚ such that Y_{pd}≧3 Yₕₚ.

The mean impurity content of the first and third hydrogen-rich stream is obtained from the following formula:

$${Y}_{pd} = \frac{{Y}_{ps} * {t}_{ϕ} - {Y}_{hp} * [ {t}_{1} - {t}_{0} ]}{{t}_{ϕ} - [ {t}_{1} - {t}_{0} ]}$$

which is simplified to

$${Y}_{pd} = \frac{{Y}_{ps} * {t}_{ϕ}}{{t}_{ϕ} - [ {t}_{1} - {t}_{0} ]} if {Y}_{hp} << {Y}_{ps}$$

There will be, for example, for an interval [t₁-t₀] representing ⅓ of the phase time and Yₕₚ<<Yₚₛ, a degraded mean purity Y_{pd} that will be 1.5 times higher than the standard mean impurity Yₚₛ.

In other words, if ⅓ of the H₂ flow produced by the PSA was withdrawn for a high-purity application, it would be necessary to adjust the PSA such that the ⅔ of the flow remaining, sent to the initial client, are at the standard purity level. This adjustment therefore involves passing to a new mean content (calculated over a complete phase time) that is 1.5 times lower, the effect of which on the yield of the PSA will not be significant, relative to a drop in yield caused by the adjustment of the PSA that makes it possible to obtain the purity Yₕₚ over the whole of the H₂ flow produced.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary a range is expressed, it is to be understood that another embodiment is from the one.

Optional or optionally means that the subsequently described event or circumstances may or may not occur. The description includes instances where the event or circumstance occurs and instances where it does not occur.

Ranges may be expressed herein as from about one particular value, and/or to about another particular value. When such particular value and/or to the other particular value, along with all combinations within said range.

All references identified herein are each hereby incorporated by reference into this application in their entireties, as well as for the specific information for which each is cited.

1-13. (canceled)

14. A process for producing hydrogen from a gas mixture comprising hydrogen (H₂), and at least one impurity to be eliminated using an H₂ PSA unit comprising N adsorbers subjected to a pressure cycle of duration T with N>1, comprising a production phase comprising the following successive steps:
a) said gas mixture is introduced into said unit,
b) at least a first hydrogen-enriched stream having a mean impurity content Y_{pd} is extracted,
c) at least a second hydrogen-enriched stream having a mean impurity content Yₕₚ is extracted,
d) at least a third hydrogen-enriched stream having a mean impurity content Y_{pd}′ is extracted,
with Y_{pd}>3Yₕₚ and Y_{pd}′>3Yₕₚ, and the steps b), c) and d) being carried out during the production phase of each of the cycles of the N adsorbers.

15. The production process as claimed in claim 14, wherein
at each instant t of the pressure cycle, a single adsorber is in the production phase;
the H₂ PSA unit is characterized by a phase time t_{φ}=T/N; and
step c) is carried out over a duration d₁ such that 0.05 t_{φ}<d₁<0.5 t_{φ}.

16. The production process as claimed in claim 15, wherein step b) is carried out over a duration d₀ such that 0<d₀<0.4 t_{φ}.

17. The production process as claimed in claim 15, wherein step d) is carried out over a duration d₂ such that 0.3 t_{φ}<d₂<0.95 t_{φ}.

18. The production process as claimed in claim 15, wherein the N adsorbers are connected to one and the same hydrogen production line and steps b), c) and d) are carried out by means of one or two valves located on this hydrogen production line.

19. The production process as claimed in claim 15, wherein steps b), c) and d) are carried out by means of N valves located at the outlet of the N adsorbers.

20. The production process as claimed in claim 14, wherein:
several adsorbers are simultaneously in the production phase during the cycle;
the H₂ PSA unit is characterized by a phase time t_{φ}=T/N and by a production time tₚ that is a multiple of the phase time; and
step c) is carried out over a duration d₁ such that 0.05 tₚ<d₁<0.5 tₚ.

21. The production process as claimed in claim 20, wherein step b) is carried out over a duration d₀ such that 0<d₀<0.4 tₚ.

22. The production process as claimed in claim 20, wherein step d) is carried out over a duration d₂ such that 0.3 tₚ<d₂<0.95 tₚ.

23. The production process as claimed in claim 20, wherein steps b), c) and d) are carried out by means of one to N valves located at the outlet of one to N adsorbers.

24. The production process as claimed in claim 20, wherein the N adsorbers follow the pressure cycle in phase.

25. The production process as claimed in claim 20, wherein the N adsorbers follow the pressure cycle with a phase shift.

26. The production process as claimed in claim 14, wherein the gas mixture is a natural gas steam reforming gas, resulting from a partial oxidation, coal gasification or shift process.
